(19) United States
(12) Patent Application Publication
(10) Pub. No.: US 2020/0343496 A1
(43) Pub. Date: Oct. 29, 2020

(54) Battery Module And Battery Pack

(71) Applicant: Contemporary Amperex Technology Co., Limited, Ningde City (CN)

(72) Inventors: Haizu JIN, Ningde City (CN); Kaijie YOU, Ningde City (CN); Yuepan HOU, Ningde City (CN); Jun MA, Ningde City (CN); Weilong LIN, Ningde City (CN); Xingdi CHEN, Ningde City (CN)

(21) Appl. No.: 16/717,278

(22) Filed: Dec. 17, 2019

(30) Foreign Application Priority Data
Apr. 26, 2019 (CN) 201920582840.1

(51) Int. Cl. H01M 2/10; H01M 2/20; H01M 2/02

(52) U.S. Cl. CPC H01M 2/1077; H01M 2/0212; H01M 2/1094; H01M 2/202

(57) ABSTRACT

The present disclosure discloses a battery module and a battery pack. The battery module comprises a plurality of battery cells and a first spacer. The cell comprises a first surface provided with an electrode terminal, a second surface opposite to the first surface, and side faces located between the first surface and the second surface. The side faces comprise abutting faces and connecting faces connected with the abutting faces; there are a plurality of battery cells, and the plurality of battery cells are arranged in a length direction, and the abutting faces of all the battery cells face to each other. At least part of the first spacer is arranged between the abutting faces of two adjacent battery cells, and fixed to two abutting faces, and the first spacer is used for fixation to a case.

### CROSS-REFERENCE TO RELATED APPLICATIONS

This disclosure claims priority to Chinese Patent Application No. 201920582840.1 filed Apr. 26, 2019, the disclosures of which are hereby incorporated in their entirety by reference.

### FIELD OF THE INVENTION

The present disclosure relates to the field of batteries, and in particular relates to a battery module and a battery pack.

### DESCRIPTION OF RELATED ART

A battery module includes an upper baseplate, a lower baseplate, and a plurality of battery cells fit to each other in parallel. The battery cells are fixed between the upper baseplate and the lower baseplate.

The inventor finds at least the following problems in the device known to the inventors: the battery module deforms due to expansion during its operation; and the existing battery module is unreasonable in structure, causing deformation accumulation of the battery cells, so that the performance of the battery module is damaged.

### SUMMARY OF THE INVENTION

The present disclosure provides a battery module and a battery pack, for optimizing the structure of the battery module.

Some embodiments of the present disclosure provide a battery module, including:

a plurality of battery cells, each of which comprising a first surface provided with an electrode terminal, a second surface opposite to the first surface, and side faces located between the first surface and the second surface; wherein the side faces comprise abutting faces and connecting faces connected with the abutting faces; and the plurality of battery cells are arranged in a length direction, and the abutting faces of all the battery cells face to each other; and

a first spacer, at least part of which being arranged between the abutting faces of two adjacent battery cells, and fixed to the abutting faces of the two adjacent battery cells, wherein the first spacer is configured to fix to a case.

In some embodiments, there is a gap between the abutting faces of the two adjacent battery cells.

In some embodiments, a thermal insulation layer is mounted within the gap.

In some embodiments, the first spacer comprises:

a first spacing part, arranged between the abutting faces of the two adjacent battery cells and fixed to the abutting faces of the two adjacent battery cells; and

a first connecting part, connected with the first spacing part, the first connecting part being located beyond the abutting faces of the two adjacent battery cells, and fixed to the connecting faces or the second surfaces of the two adjacent battery cells.

In some embodiments, one first spacing part is fixed between the abutting faces of every two adjacent battery cells.

In some embodiments, the first spacing part is connected with the abutting faces of the two adjacent battery cells through binder.

In some embodiments, the first connecting part is connected with the connecting faces or the second surfaces of the two adjacent battery cells through binder.

In some embodiments, the first connecting part is detachably connected or integrated with the first spacing part.

In some embodiments, the length of the first connecting part is greater than that of each of the abutting faces, and a portion of the first connecting part located at an outer side of the abutting faces is provided with a connecting structure for fixation to the case.

In some embodiments, the connecting structure comprises screw holes, the hole center line of which is substantially parallel to the central line in a thickness direction of the first spacing part.

In some embodiments, the battery module further comprises a second spacer, at least part of which is arranged between the abutting faces of the two adjacent battery cells, and fixed to the abutting faces of the two adjacent battery cells.

In some embodiments, the second spacer comprises:

a second spacing part, arranged between abutting faces of the two adjacent battery cells and fixed to the abutting faces of the two adjacent battery cells; and

a second connecting part, fixedly connected or integrated with the second spacing part and located beyond the abutting faces of the two adjacent battery cells.

In some embodiments, one second connecting part is connected with a plurality of the second spacing parts, and one second spacing part is provided between the abutting faces of every two adjacent battery cells.

In some embodiments, the battery module further comprises:

an end plate, wherein the end plate is located at least one side of the plurality of battery cells; and the end plate is fixedly connected with the second connecting part, or the end plate is configured to be fixedly connected with the case; wherein the case is configured to mount the battery module.

In some embodiments, the second connecting part and the end plate are fixed to the case through a screw.

Some other embodiments of the present disclosure provide a battery pack, comprising a case and the battery module provided in any technical solution of the present disclosure, the battery module being mounted within the case.

In some embodiments, a first fixing part is mounted at the bottom of the case, and a connecting structure on a first connecting part of the battery module is detachably connected with the first fixing part.

In some embodiments, a second fixing part is mounted at the bottom of the case, and an end plate of the battery module and/or a second connecting part are detachably connected with the second fixing part though a screw.

In the battery module provided by the technical solution described above, the first spacer is arranged in a direction of accumulation caused by expansion of the battery module; that is, the first spacer is arranged between abutting faces of the battery cells arranged in a row, the size of the first spacer being smaller than that of the abutting faces; thus, due to the presence of the first spacer, there is the gap between the abutting faces of the two adjacent battery cells, and the gap provides a buffering space for expansion of the battery cells, so that the expansion of the battery cells is limited within the space, and expansion accumulation of the adjacent battery cells due to contact is reduced or even avoided. Moreover, due to proving the first spacer, the battery cells do not contact each other, so that heat transfer between the battery cells is effectively reduced, and the heat dissipation effect is better.

### BRIEF DESCRIPTION OF THE DRAWINGS

The drawings described here are used for providing further understanding of the present disclosure, and are part of the present application, and the schematic embodiments of the present disclosure and description thereof are intended for explaining the present disclosure, rather than improperly limiting the present disclosure. In the drawings:

FIG. 1 shows an exploded diagram of a battery module provided in some embodiments of the present disclosure;

FIG. 2 shows an exploded diagram of a cell of a battery module provided in some embodiments of the present disclosure;

FIG. 3 shows an enlarged diagram after installation at A of the battery module illustrated in FIG. 1;

FIG. 4 shows a three-dimensional diagram of a battery module provided in some embodiments of the present disclosure;

FIG. 5 shows a structural diagram of a first spacer of a battery module provided in some embodiments of the present disclosure;

FIG. 6 shows a structural diagram of a second spacer of a battery module provided in some embodiments of the present disclosure;

FIG. 7 shows an exploded diagram of a battery pack provided in some embodiments of the present disclosure;

FIG. 8 shows an exploded diagram of a battery pack provided in some other embodiments of the present disclosure;

FIG. 9 shows an exploded diagram of a battery pack provided in still other embodiments of the present disclosure; and

FIG. 10 shows an exploded diagram of a battery pack provided in yet other embodiments of the present disclosure.

### DESCRIPTION OF THE INVENTION

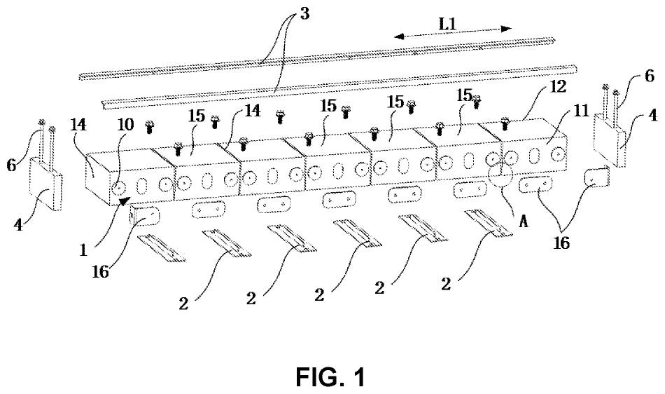

Technical solutions provided by the present disclosure are described in more detail below in conjunction with FIGS. 1-10.

Some embodiments of the present disclosure provide a battery pack, comprising a case 5 and a battery module provided in any technical solution of the present disclosure, the battery module being mounted within the case 5.

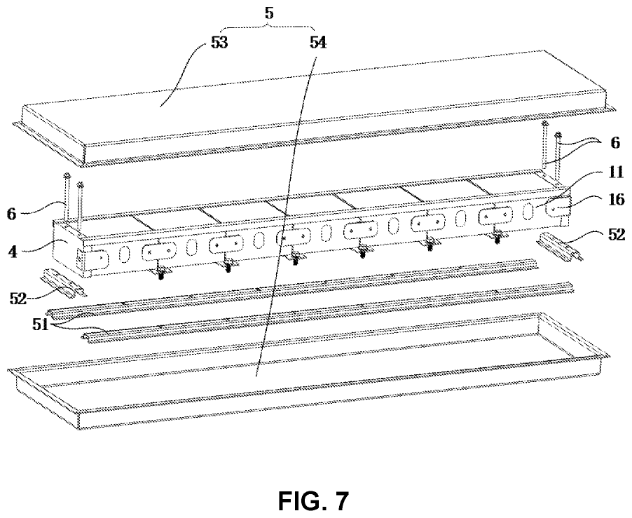

Using a battery cell 1 with a cuboid structure as an example, each battery cell 1 comprises four side faces 13. There are four manners of arrangement of the battery cells 1 in a row, respectively as shown in FIGS. 7 to 10.

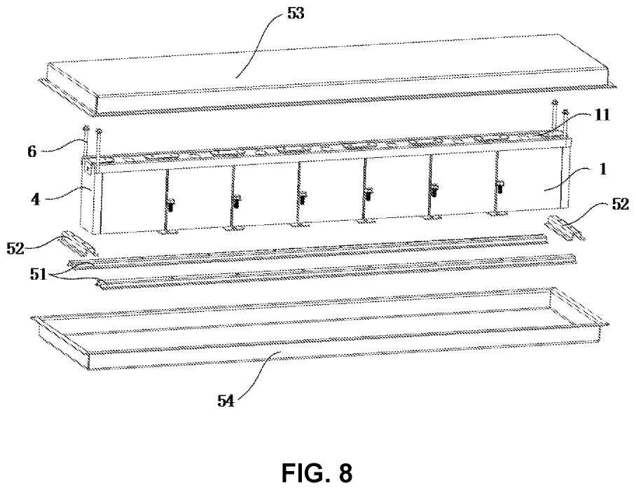

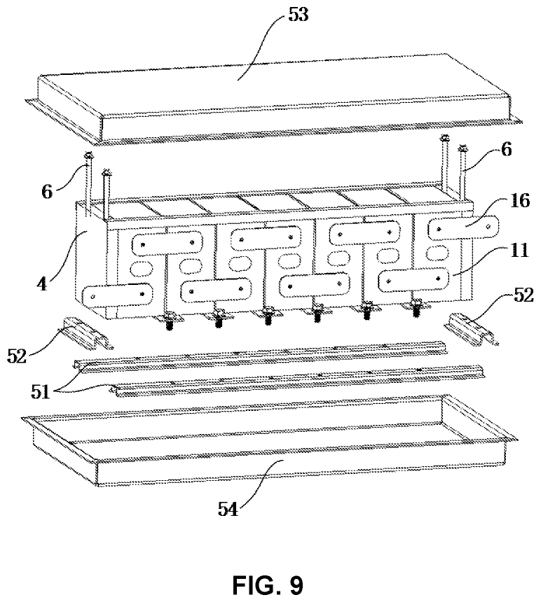

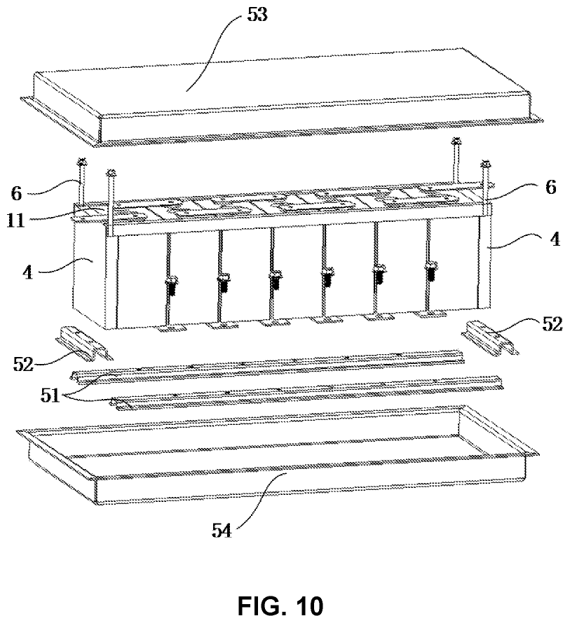

FIG. 7 schematically shows smaller side faces 13 serve as abutting faces 14, and a first surface 11 is arranged forward. FIG. 8 schematically shows smaller side faces 13 serve as abutting faces 14, and a first surface 11 is arranged upward. FIG. 9 schematically shows larger side faces 13 serve as the abutting faces 14, and the first surface 11 is arranged forward. FIG. 10 schematically shows the larger side faces 13 serve as the abutting faces 14, and the first surface 11 is arranged upward.

Relevant introduction of the battery module is provided below.

Referring to FIG. 1, some embodiments of the present disclosure provide a battery module, comprising battery cells 1 and a first spacer 2. The battery cell 1 comprises a first surface 11 provided with an electrode terminal 10, a second surface 12 opposite to the first surface 11, and side faces 13 located between the first surface 11 and the second surface 12. The side faces 13 comprise abutting faces 14 and connecting faces 15 connected with the abutting faces 14. A plurality of battery cells 1 are arranged in a length direction, and the abutting faces 14 of all the battery cells 1 face to each other. The length direction means a length direction L1 of the case 5, as shown in FIG. 1.

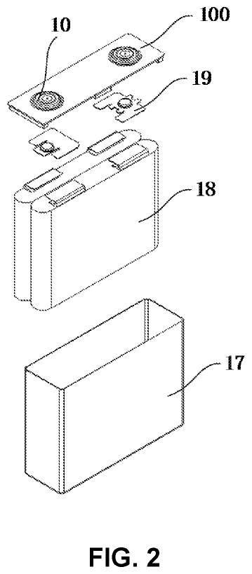

Referring to FIG. 2, the structure of the battery cell 1 is introduced below.

The battery cell 1 comprises a housing 17, an electrode assembly 18 arranged within the housing 17, connectors 19 arranged at an end of the electrode assembly 18, and a cover plate 100 that covers the connectors 19 and the end of the electrode assembly 18. The cover plate 100 is provided with the electrode terminals 10.

The housing 17 has a closed end and an open end. The cover plate 100 is arranged at the opening of the housing 17. The electrode assembly 18 is mounted within the housing 17 via the opening.

An outer surface of the cover plate 100 serves as the first surface 11 of the cell described below, and a surface of the housing 17 opposite to the open end serves as the second surface 12 of the cell described below. The four side faces of the housing 17 serve as the four side faces of the battery cell 1.

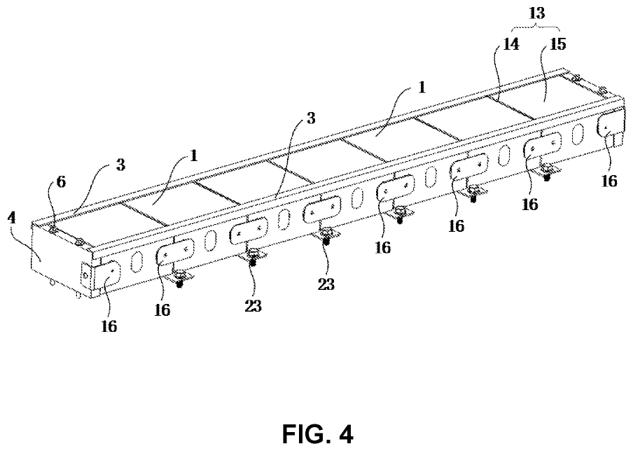

See FIG. 1, which schematically shows the three-dimensional structure of the battery cell 1. Using the battery cell 1 with a cuboid structure as an example, the battery cell 1 comprises the first surface 11, the second surface 12 and the four side faces 13. The first surface 11 is provided with a positive and a negative electrode terminal. Among the four side faces 13 of battery cell 1, the side face 13 fit to another battery cell 1 is an abutting face 14, and the side face parallel to the abutting face is also an abutting face 14. Other side faces 13 than the abutting faces 14 are connecting faces 15. Referring to FIG. 1 or FIG. 4, the battery cell 1 has two abutting faces 14 and two connecting faces 15.

Referring to FIG. 1, the battery cells 1 arranged in a row are electrically connected. Specifically, the electrode terminals 10 of the battery cells 1 are electrically connected through connecting sheets 16.

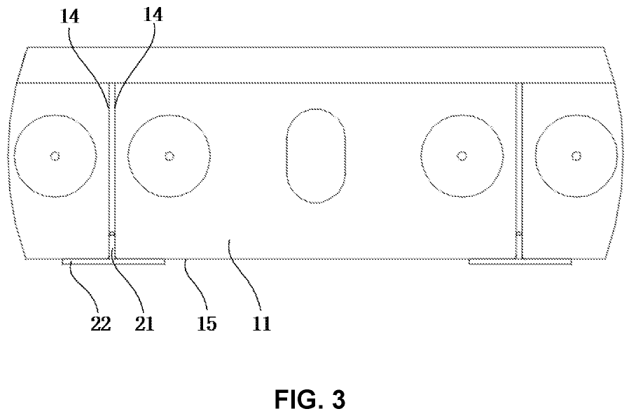

Referring to FIG. 3, in some embodiments, there is a gap between abutting faces 14 of the two adjacent battery cells 1, so that heat dissipation of the battery cells 1 is better.

Referring to FIG. 3, the size of a first spacing part 21 is smaller than that of the abutting face 14, to provide the gap between the abutting faces 14 of the two adjacent battery cells 1.

The size of the first spacer 2 is smaller than that of the abutting face 14, so that due to the presence of the first spacer 2 between the abutting faces 14 of the two adjacent battery cells 1, there is the gap between the abutting faces 14 of the two adjacent battery cells 1, the width of the gap being 1 mm-10 mm for example. The presence of the gap limits the expansion of the two abutting faces 14 within the gap. For the battery cells arranged in a row, the battery cells 1 do not directly abut against the adjacent battery cells 1 after expansion, so that the battery cells arranged in a row as a whole do not deform excessively due to expansion.

In some other embodiments, a thermal insulation layer (not shown in the figures) is mounted within the gap, to reduce temperature influence of the two adjacent battery cells 1.

Referring to FIGS. 1, 3 and 4, in some embodiments, between every abutting faces 14 of the two adjacent battery cells 1 is arranged at least part of the first spacer 2; that is, the first spacing part 21 is arranged therebetween. The first spacing part 21 enables the battery cells 1 to be connected stably and firmly into a whole.

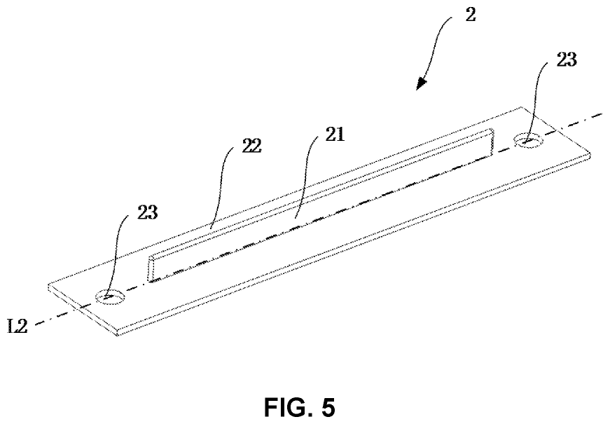

Referring to FIGS. 3 and 5, in some embodiments, the first spacer 2 comprises the first spacing part 21 and a first connecting part 22. One first spacing part 21 is arranged between abutting faces 14 of every two adjacent battery cells 1, and connected to the two abutting faces 14. The first connecting part 22 and the first spacing part 21 are interconnected, specifically fixedly interconnected or integrated for example. The first connecting part 22 is located beyond the abutting faces 14 of the two adjacent battery cells 1, and is fixedly connected with the connecting faces 15 or the second surfaces 12 of the two adjacent battery cells 1.

The first connecting part 22 and the first spacing part 21 are connected through binder for example. The first connecting part 22 and the connecting faces 15 or the second surfaces 12 of the two adjacent battery cells 1 are connected through binder for example.

Depending on the placing direction of the battery cells 1, the first connecting part 22 is connected with the connecting faces 15 or the second surface 12. FIGS. 4, 7 and 9 schematically show connections between the first connecting part 22 and the connecting faces 15. FIGS. 8 and 10 schematically show connections between the first connecting part 22 and the second surfaces 12 of the two adjacent battery cells 1.

Specifically, as the battery cells 1 have a cuboid structure, the first connecting part 22 being fit to the connecting faces 15 is conducive to the structural stability of the entire battery module, and therefore optionally, both the first connecting part 22 and the first spacing part 21 are flat plates, and the first connecting part 22 is perpendicular to the first spacing part 21.

The first connecting part 22 and the connecting faces 15 of the two adjacent battery cells 1 are fixedly connected through an adhesive for example.

The first connecting part 22 is fixed to the connecting faces 15 of the two adjacent battery cells 1, so that the entire battery module has more fixing points, and the fixing points are distributed more uniformly. When the battery module is used to in the battery pack later, the batter pack bears forces more excellently, and is better in structural strength and structural reliability.

Referring to FIG. 4, in some embodiments, the length of the first connecting part 22 is greater than that of the abutting faces 14, and the portion of the first connecting part 22 located at the outer side of the abutting faces 14 is provided with a connecting structure for connection with the case 5. The case 5 is used for mounting the battery module.

Referring to FIGS. 5 and 7, the connecting structure 23 is screw holes for example, in which bolts are mounted to install the battery module to the case 5.

Referring to FIGS. 1 and 5, the connecting structure 23 comprises screw holes, circle centers of which are located on a connecting line L2 of the central line in a thickness direction of the first spacing part 21, so that the areas of the portions of the first connecting part 22 located on two sides of the first spacing part 21 are substantially equal, and the connecting area of the first connecting part 22 and one of the two adjacent battery cells 1 is substantially equal to that of the first connecting part 22 and the other of the two adjacent battery cells 1, which makes the entire battery module good in structural stability.

Referring to FIGS. 1, 4 and 6, in some embodiments, the battery module further comprises a second spacer 3, wherein at least part of the second spacer 3 is arranged between the abutting faces 14 of two adjacent battery cells 1, and connected to the two abutting faces 14, with a gap formed between the second spacer 3 and the first spacer 2.

The gap between the second spacer 3 and the first spacer 2 is an expansion space for expansion of the battery cells 1. Providing the second spacer 3 makes the gaps between every two connected battery cells 1 more uniform, and reduces the phenomenon that some part of the gaps are greater and other part of the gaps are smaller.

Referring to FIGS. 1, 4 and 6, in some embodiments, the second spacer 3 comprises a second spacing part 31 and a second connecting part 32. One second spacing part 31 is arranged between the abutting faces 14 of every two adjacent battery cells 1, and connected to the two abutting faces 14. The second connecting part 32 and the second spacing part 31 are interconnected fixedly or integrated. The second connecting part 32 is located beyond the abutting faces 14 of the two adjacent battery cells 1.

In some embodiments, there is a gap between the second spacing part 31 and the first spacer 2, and gap is conducive to heat dissipation of the battery cells 1.

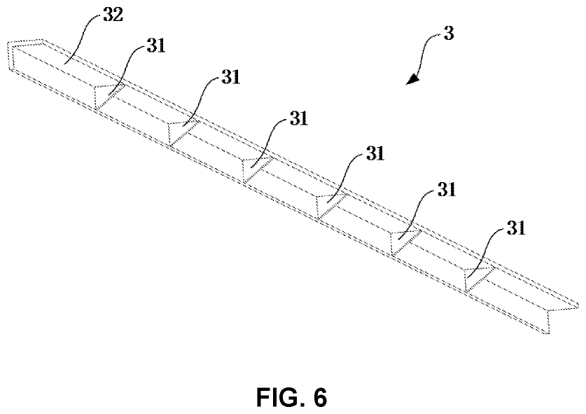

Referring to FIG. 6, to fit the second connecting part 32 to the connecting faces 15 of the battery cells 1, the second connecting part 32 is perpendicular to the second spacing part 31.

Referring to FIG. 6, in some embodiments, the second connecting part 32 is in a right-angle type, specifically an L-shaped plate for example, and the second spacing part 31 is connected with the second connecting part 32, and the second connecting part 32 is arranged at a corner of the battery cells 1.

Referring to FIGS. 1 and 4, a second spacer 3 is provided at each of two adjacent edges of a row of battery pack. Each second spacer 3 is provided with a plurality of the second connecting parts 32. Two second spacing parts 31 are provided between the abutting faces 14 of every two adjacent battery cells 1.

The first spacer 2 is located at one end of the gap of the two adjacent battery cells 1, and the two second spacers 3 are located at the other end of the gap of the two adjacent battery cells 1. The thickness of the first spacer 2 is equal to that of the two second spacers 3. By means of the first spacer 2 and the two second spacers 3, the sizes of the gap at the two ends are substantially same. Such configuration makes the battery module more stable in structure and tidy.

To provide more fixing points for the battery module and make the battery module more stable in structure, in some embodiments, the second connecting part 32 is fixedly connected to the connecting faces 15 of both the two adjacent battery cells 1.

Specifically, the second connecting part 32 and the connecting faces 15 of the two adjacent battery cells 1 are connected through binder.

Referring to FIGS. 4 and 6, in some embodiments, one second connecting part 32 is provided with a plurality of second spacing parts 31, and the second spacing parts 31 are provided between the abutting faces 14 of every two adjacent battery cells 1 of the battery cells 1 arranged in a row.

Referring to FIGS. 4, and 7-10, in some embodiments, the battery module further comprises an end plate 4. The end plate 4 is located at least one side of the plurality of battery cells 1. At least one of two ends of the battery cells 1 arranged in a row is provided with at least one end plate 4. The end plate 4 is fixedly connected with the second connecting part 32; or the end plate 4 is configured to fixedly connect with the case 5, wherein the case 5 is used for mounting the battery module.

The end plate 4 and the second connecting part 32 are fixedly connected to form a relatively stable and firm frame, and the battery cells 1 arranged in a row are located within the frame. The structure makes the structure of the battery module more stable and firmer.

In some embodiments, screws 6 connect both the second connecting part 32 and the end plate 4 to the case 5.

This structure ensures that the battery module is mounted inside the case 5 more stably, firmly and reliably.

The mounting relation of the battery module inside the case 5 is introduced below.

Referring to FIGS. 7 to 10, the case 5 comprises a first case 53 and a second case 54. The first case 53 and the second case 54 form an accommodating cavity, and the battery module is mounted inside the accommodating cavity.

A first fixing part 51 and a second fixing part 52 described below are mounted on the inner wall of the second case 54. Both the first fixing part 51 and the second fixing part 52 are fixed to the battery module, to achieve multi-point fixation of the battery module inside the accommodating cavity, so that the battery module has more fixing points which are more dispersed, and the battery module bears forces more uniformly.

Specifically, in some embodiments, the first fixing part 51 is mounted at the bottom of the case 5, and the connecting structure 23 on the first connecting part 22 of the battery module is detachably connected with the first fixing part 51.

The first fixing part 51 is a metal rod provided with screw holes for example, and is welded to the inner wall surface of the second case 54.

The connecting structure 23 is screw holes for example. Bolts pass through the screw holes to achieve detachable connection between the first connecting part 22 and the first fixing part 51.

In some embodiments, the second fixing part 52 is mounted at the bottom of the case 5, and the end plate 4 of the battery module and the second connecting part 32 are detachably connected with the second fixing part 52 through screws.

The second fixing part 52 is a metal rod provided with screw holes for example, and is welded to the inner wall surface of the second case 54.

Referring to FIGS. 7 to 10, in some embodiments, there are two first fixing parts 51 and two second fixing parts 52, and the first fixing parts 51 and the second fixing parts 52 form a rectangle matched with the battery cells in a row. It is understood that other numbers of first fixing part 51 and second fixing part 52 with other structures are also adopted to form the required connecting frame.

In some embodiments, one or more battery modules are mounted within the case 5.

In description of the present disclosure, it needs to be understood that orientation or position relations denoted by the terms “center”, “longitudinal”, “transverse”, “front”, “rear”, “left”, “right”, “vertical”, “horizontal”, “top”, “bottom”, “inner”, “outer” and the like are orientation or position relations based on illustration in the drawings, and are only intended to facilitate describing the present disclosure and simplifying description, instead of indicating or implying the denoted devices or elements necessarily have specific orientations or are constructed and operated in specific orientations, and thus they should not be understood as limiting the protection scope of the present disclosure.

Finally, it should be noted that the above embodiments are only used for illustrating rather than limiting the technical solutions of the present disclosure. Although the present disclosure is described in detail with reference to the foregoing embodiments, those of ordinary skill in the art should understand that they still can make modifications to the technical solutions disclosed in the foregoing embodiments or make equivalent substitutions to part of technical features thereof, but such modifications or substitutions should not cause the essence of the corresponding technical solutions to depart from the spirit and scope of the technical solutions of the embodiments of the present disclosure.

1. A battery module, comprising:
a plurality of battery cells, each of which comprising a first surface provided with an electrode terminal, a second surface opposite to the first surface, and side faces located between the first surface and the second surface; wherein the side faces comprise abutting faces and connecting faces connected with the abutting faces; and the plurality of battery cells are arranged in a length direction, and the abutting faces of all the battery cells face to each other; and
a first spacer, at least part of which being arranged between the abutting faces of two adjacent battery cells, and fixed to the abutting faces of the two adjacent battery cells, wherein the first spacer is configured to fix to a case.

2. The battery module of claim 1, wherein there is a gap between the abutting faces of the two adjacent battery cells.

3. The battery module of claim 2, wherein a thermal insulation layer is mounted within the gap.

4. The battery module of claim 1, wherein the first spacer comprises:
a first spacing part, arranged between the abutting faces of the two adjacent battery cells and fixed to the abutting faces of the two adjacent battery cells; and
a first connecting part, connected with the first spacing part, the first connecting part being located beyond the abutting faces of the two adjacent battery cells, and fixed to the connecting faces or the second surfaces of the two adjacent battery cells.

5. The battery module of claim 4, wherein one first spacing part is fixed between the abutting faces of every two adjacent battery cells.

6. The battery module of claim 4, wherein the first spacing part is connected with the abutting faces of the two adjacent battery cells through binder.

7. The battery module of claim 4, wherein the first connecting part is connected with the connecting faces or the second surfaces of the two adjacent battery cells through binder.

8. The battery module of claim 4, wherein the first connecting part is detachably connected or integrated with the first spacing part.

9. The battery module of claim 4, wherein the length of the first connecting part is greater than that of each of the abutting faces, and a portion of the first connecting part located at an outer side of the abutting faces is provided with a connecting structure for fixation to the case.

10. The battery module of claim 9, wherein the connecting structure comprises screw holes, a hole center line of which is substantially parallel to a central line in a thickness direction of the first spacing part.

11. The battery module of claim 1, further comprising a second spacer, at least part of which is arranged between the abutting faces of the two adjacent battery cells, and fixed to the abutting faces of the two adjacent battery cells.

12. The battery module of claim 11, wherein the second spacer comprises:
a second spacing part, arranged between abutting faces of the two adjacent battery cells and fixed to the abutting faces of the two adjacent battery cells; and
a second connecting part, fixedly connected or integrated with the second spacing part and located beyond the abutting faces of the two adjacent battery cells.

13. The battery module of claim 12, wherein one second connecting part is connected with a plurality of the second spacing parts, and one second spacing part is provided between the abutting faces of every two adjacent battery cells.

14. The battery module of claim 12, further comprising:
an end plate, wherein the end plate is located at least one side of the plurality of battery cells; and the end plate is fixedly connected with the second connecting part, or the end plate is configured to be fixedly connected with the case; wherein the case is configured to mount the battery module.

15. The battery module of claim 14, wherein the second connecting part and the end plate are fixed to the case through a screw.

16. A battery pack, comprising a case and the battery module of claim 1, the battery module being mounted within the case.

17. The battery pack of claim 16, wherein a first fixing part is mounted at the bottom of the case, and a connecting structure on a first connecting part of the battery module is detachably connected with the first fixing part.

18. The battery pack of claim 16, wherein a second fixing part is mounted at the bottom of the case, and at least one of an end plate of the battery module and a second connecting part is detachably connected with the second fixing part though a screw.
